(19) United States
(12) Patent Application Publication
(10) Pub. No.: US 2008/0045672 A1
(43) Pub. Date: Feb. 21, 2008

(54) Chelate Polymerization

(75) Inventors: Christian Herzig, Waging (DE); Christine Weizhofer, Kirchdorf (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/836,314

(22) Filed: Aug. 9, 2007

(30) Foreign Application Priority Data
Aug. 16, 2006 (DE) 10 2006 038 062.2

(51) Int. Cl. C08L 79/02; C08L 83/04

(52) U.S. Cl. 525/474; 525/509

(57) ABSTRACT

Polymer-containing compositions contain:
a) a polymer (I) containing at least two functional groups selected from the group consisting of β-ketocarbonyl and β-enaminocarbonyl functions,
b) a compound (II) of a metal selected from the group consisting of the transition metals and the lanthanides and main groups 1, 2, 3 and 4 with the exception of the boron and carbon.

### BACKGROUND OF THE INVENTION

1. Field of the Invention

The invention relates to polymer-containing compositions.

2. Background Art

CA 140: 128775 describes Schiff's bases which are derived from 2,4 dihydroxybenzaldehyde and α, ω-aminoalkylsiloxanes and form chelates with metal ions. These are solids having a defined melting point which depends on the aminosiloxane used. Only by means of subsequent reactions such as condensation of the phenolic end groups by means of water-withdrawing agents or esterification with 1,3 bis(carboxypropyl)tetramethyldisiloxane are polyester structures formed.

Organic polymers which contain bipyridine or terpyridine groups and form higher polymers, copolymers or three-dimensional networks on addition of ruthenium compounds are described in PMSE Preprints 2002, 86, 68 and 2002, 87, 209. In these, the polymer-bonded pyridine ligands are coordinated to the central ruthenium atom.

U.S. Pat. No. 6,469,134 B2 claims switchable systems which comprise polymer-bonded bipyridine or terpyridine ligands and central ruthenium atoms and can be, depending on external influences, crosslinked or liquid. Temperature, pH or an external electric field can be used as control parameters.

### SUMMARY OF THE INVENTION

It is an object of the invention to improve the prior art and in particular to form polymers which can easily be polymerized and can also be easily crosslinked.

### DETAILED DESCRIPTION OF THE PREFERRED EMBODIMENT(S)

The invention provides polymer-containing compositions comprising: a) polymer (I) containing at least two functional groups selected from the group consisting of β-ketocarbonyl and β-enaminocarbonyl functions, b) compound (II) of a metal selected from the group consisting of the transition metals and the lanthanides and main groups 1, 2, 3 and 4 with the exception of boron and carbon in main groups 3 and 4. The polymers are preferably polyester, polyamide, polyether, or polyethylene oxide polymers, more preferably siloxane polymers.

The siloxane polymers according to the invention are preferably linear polysiloxanes having the functional groups at the ends of the chain or/and in lateral positions, or both at the ends of the chains and in lateral positions. Preference is also given to branched polysiloxanes having the functional groups at the ends of the chain or on lateral positions or both at the ends of the chain and in lateral positions or additionally at the branching points, or only at the branching points.

Particular preference is given to the following: β-ketocarbonyl-functional siloxane polymers which contain at least one trivalent radical B of the general formula

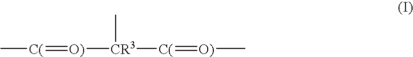

where
R³ is a hydrogen atom or a monovalent hydrocarbon radical having from 1 to 30 carbon atoms, preferably a hydrogen atom. In the radical B in formula (I), preference is given to not more than one of the three free valences being bound to a heteroatom.

The siloxane polymers preferably contain at least 2 radicals B on average per molecule, more preferably from 2 to 20 radicals B, and most preferably from 3 to 10 radicals B. The organic radicals B are preferably bound via Si—C groups to the siloxane part of the siloxane polymers.

If none of the free valences of the trivalent radical B is bound to a heteroatom, the siloxane polymers according to the invention preferably contain at least one SiC-bonded radical B¹ selected from the group consisting of the general formula

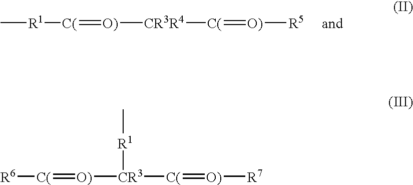

where R³ is as defined above,
R¹ is a divalent organic radical, preferably a divalent organic radical which has from 1 to 20 carbon atoms and can contain heteroatoms selected from the group consisting of oxygen, sulfur and nitrogen, except in the end positions, more preferably a hydrocarbon radical having from 1 to 20 carbon atoms, and most preferably a hydrocarbon radical having from 1 to 4 carbon atoms,

### R⁴ is a hydrogen atom or a hydrocarbon radical having from 1 to 30 carbon atoms, preferably a hydrogen atom, and

### R⁵, R⁶ and R⁷ are each a hydrocarbon radical having from 1 to 30 carbon atoms.

The radicals B¹ of the formulae (II) and (III) have the structure of a substituted acetylacetone which is bound via R¹ to a siloxane polymer.

If one of the free valences of the trivalent radical B is bound to a heteroatom, the siloxane polymers according to the invention preferably contain at least one SiC-bonded radical B² selected from the group consisting of the general formulae

—R¹—Y—C(═O)—CHR³—C(═O)—CH₂R³ (IV) and

—R¹—Y—C(═O)—CR³═C(—OH)—CH₂R³ (V)

where R¹ and R³ are as defined above,

### Y is an oxygen atom or a radical of the formula (NR⁸— R¹′)_{z}—NR²—,

where R¹′ has one of the meanings of R¹,

### R² is a hydrogen atom or a hydrocarbon radical having from 1 to 18 carbon atoms, preferably a hydrogen atom,

### R⁸ has one of the meanings of R² or is a radical of the formula —C(═O)—CHR³—C(═O)CH₂R³ or —C(═O)—CR³═C(—OH)—CH₂R³,

z is 0 or an integer from 1 to 10, preferably 0, 1 or 2.

The radicals B² of the formulae (IV) and (V) are bound via the radicals R¹ to the siloxane polymer.

The radicals B² of the formulae (IV) and (V) are tautomeric groups. The siloxane polymers according to the invention preferably contain at least 2 radicals B² from the group consisting of the formulae (IV) and (V) per molecule and can contain only radicals of the formula (IV), only radicals of the formula (V) or both together. Since tautomeric groups can be converted into one another, their respective content can change as a function of external conditions. Their ratio can therefore fluctuate within a wide range and can be from about 1000:1 to about 1:1000.

The enol content of the siloxane polymers according to the invention leads to a slightly acidic character of these substances which depends critically on the structural parameters and substituents of the group of the general formula (I). The enolizable groups preferably have a pKs of greater than 5.0, more preferably from 6.0 to 15.0, and especially from 7.0 to 14.0.

The siloxane polymers preferably contain from 5 to 5000 Si atoms, more preferably from 50 to 1000 Si atoms, per molecule. They can be linear, branched, dendritic or cyclic. The siloxane polymers also encompass network structures of any size to which neither a specific nor average number of Si atoms can be assigned, as long as they contain at least 2 functional groups B of the formula (I).

In addition, preference is given to the following: β-enaminocarbonyl-functional siloxane polymers containing at least one trivalent radical E of the general formula

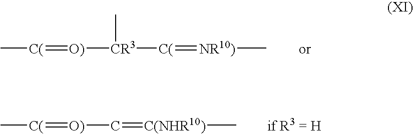

where
R³ is a hydrogen atom or a monovalent hydrocarbon radical having from 1 to 30 carbon atoms, preferably a hydrogen atom, and R¹⁰ is preferably a monovalent organic radical. The radical E can exist in the imine form or in the enamine form. In the case of the radical E in formula (XI), preference is given to not more than one of the three free valences being bound to a heteroatom.

The siloxane polymers preferably contain at least 2 radicals E on average per molecule, more preferably from 2 to 20 radicals E, and most preferably from 3 to 10 radicals E. The organic radicals E are preferably bound via Si—C groups to the siloxane part of the siloxane polymers.

If none of the free valences of the trivalent radical E is bound to a heteroatom, the siloxane polymers according to the invention preferably contain at least one SiC-bonded radical E¹ selected from the group consisting of the general formulae

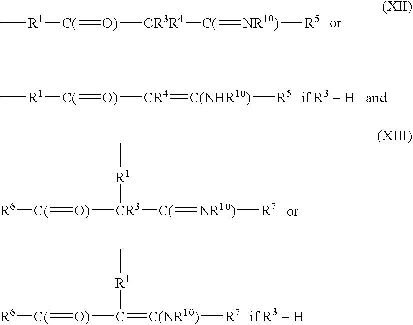

where R³ is as defined above,
R¹ is a divalent organic radical, preferably a divalent organic radical which has from 1 to 20 carbon atoms and can contain heteroatoms selected from the group consisting of oxygen, sulfur and nitrogen, except in the end positions, more preferably a hydrocarbon radical having from 1 to 20 carbon atoms, and most preferably a hydrocarbon radical having from 1 to 4 carbon atoms,

### R⁴ is a hydrogen atom or a hydrocarbon radical having from 1 to 30 carbon atoms, preferably a hydrogen atom, and

R⁵, R⁶ and R⁷ are each a hydrocarbon radical having from 1 to 30 carbon atoms. The radicals E¹ of the formulae (XII) and (XIII) have the structure of a substituted acetylacetone which is bound via R¹ to a siloxane polymer.

If one of the free valences of the trivalent radical E is bound to a heteroatom, the siloxane polymers according to the invention preferably contain at least one SiC bonded radical E² selected from the group consisting of the general formulae

—R¹—Y—C(═O)—CHR³—C(═NR¹⁰)—CH₂R³ (XIV) and

—R¹—Y—C(═O)—CR³═C(—NHR¹⁰)—CH₂R³ (XV)

where R¹ and R³ are as defined above,

### Y is an oxygen atom or a radical of the formula —(NR⁸—R¹′)_{z}—NR²—,

where R¹′ has one of the meanings of R¹,

### R² is a hydrogen atom or a hydrocarbon radical having from 1 to 18 carbon atoms, preferably a hydrogen atom,

### R⁸ has one of the meanings of R² or is a radical of the formula —C(═O)—CHR³—C(═O)—CH₂R³, —C(═O)—CR³═C(—OH)—CH₂R³, —C(═O)—CHR³—C(═NHR¹⁰)—CH₂R³ or —C(═O)—CR³═C(—NHR¹⁰)—CH₂R³,

z is 0 or an integer from 1 to 10, preferably 0, 1 or 2. The radicals E² of the formulae (XIV) and (XV) are bound via the radicals R¹ to the siloxane polymer.

The radicals E² of the formulae (XIV) and (XV) are tautomeric groups. The siloxane polymers according to the invention preferably contain at least 2 radicals E² from the group consisting of the formulae (XIV) and (XV) per molecule and may contain only radicals of the formula (XIV), only radicals of the formula (XV), or both together. Since tautomeric groups can be converted into one another, their respective content can change as a function of external conditions. Their ratio can therefore fluctuate within a wide range and can be from about 1000:1 to about 1:1000.

The siloxane polymers according to the invention preferably contain from 5 to 5000 Si atoms, more preferably from 50 to 1000 Si atoms, per molecule. They can be linear, branched, dendritic or cyclic. The siloxane polymers according to the invention also encompass network structures of any size to which neither a specific nor average number of Si atoms can be assigned, as long as they contain at least 2 functional groups E of the formula (I).

The β-ketocarbonyl-functional siloxane polymers according to the invention are preferably organopolysiloxanes comprising units of the general formula

$${X}_{a} {{R}_{c} ( {OR}^{9} )}_{d} {SiO}_{\frac{4 - ( a + c + d )}{2}} , \qquad ( VI )$$

where
X is an organic radical containing the radical B, preferably a SiC-bonded radical B¹ or B²,
   where B, B¹ and B² are as defined above,
R is a monovalent, substituted or unsubstituted hydrocarbon radical having from 1 to 18 carbon atoms per radical,
R⁹ is a hydrogen atom or an alkyl radical having from 1 to 8 carbon atoms, preferably a hydrogen atom or a methyl or ethyl radical,
a is 0 or 1,
c is 0, 1, 2 or 3 and
d is 0 or 1,
   with the proviso that the sum a+c+d is ≦3 and on average at least one radical X is present per molecule.

Preferred examples of β-ketocarbonyl-functional siloxane polymers according to the invention are organopolysiloxanes of the general formulae

X_{g}R_{3-g}SiO(SiR₂O)₁(SiRXO)ₖSiR_{3-g}X_{g} (VIa) and

(R⁹O)R₂SiO(SiR₂₀)ₙ(SiRXO)ₘSiR₂(OR⁹) (VIb)

where X, R and R⁹ are as defined above,
g is 0 or 1,
k is 0 or an integer from 1 to 30 and
l is 0 or an integer from 1 to 1000,
m is an integer from 1 to 30 and
n is 0 or an integer from 1 to 1000,
with the proviso that on average at least one radical X is present per molecule.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical and octadecyl radicals such as the n-octadecyl radical; cycloalkyl radicals such as cyclopentyl, cyclohexyl, cycloheptyl and methylcyclohexyl radicals; alkenyl radicals such as the vinyl, 5-hexenyl, cyclohexenyl, 1-propenyl, allyl, 3-butenyl and 4-pentenyl radicals; alkynyl radicals such as the ethynyl, propargyl and 1-propynyl radicals; aryl radicals such as the phenyl, naphthyl, anthryl and phenanthryl radicals; alkaryl radicals such as o-, m-, p-tolyl radicals, xylyl radicals and ethylphenyl radicals; and aralkyl radicals such as the benzyl radical, and the α- and β-phenylethyl radicals.

Examples of radicals R¹ are —CH₂CH₂—, —CH(CH₃)—, —CH₂CH₂CH₂—, —CH₂C(CH₃)H—, —CH₂CH₂CH₂CH₂—, —CH₂CH₂CH(CH₃)— and —CH₂CH₂C(CH₃)₂CH₂—,

with preference being given to the —CH₂CH₂CH₂— radical. The radical R¹ is preferably a radical of the formula —CH₂CH₂— or —CH₂CH₂CH₂—.

Examples of radicals R³ are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical and octadecyl radicals such as the n-octadecyl radical; cycloalkyl radicals such as cyclopentyl, cyclohexyl, cycloheptyl and methylcyclohexyl radicals; aryl radicals such as the phenyl, naphthyl, anthryl and phenanthryl radicals; alkaryl radicals such as o-, m-, p-tolyl radicals, xylyl radicals and ethylphenyl radicals; and aralkyl radicals such as the benzyl radical, and the α- and β-phenylethyl radicals.

Examples of hydrocarbon radicals R³ also apply to hydrocarbon radicals R², and examples of hydrocarbon radicals R³ also apply to hydrocarbon radicals R⁴, R⁵, R⁶ and R⁷.

Examples of hydrocarbon radicals R⁹ are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical.

The radicals B¹ of the formulae (II) and (III) are β-diketone groups which are bound via R¹ to a siloxane polymer either terminally, based on the diketone (formula (II)) or on the carbon atom between the two carbonyl groups (formula (III)).

Processes for preparing β-ketocarbonyl-functional siloxane polymers having radicals B¹ of the formula (II) are analogous to those known from organic chemistry. They are preferably obtained by acylation of acetoacetates by means of organosilicon compounds containing Si-bonded acid chlorides. If, for example, siloxane polymers containing Si-bonded undecanoyl chloride (R¹=—C₁₀H₂O—) are reacted with ethyl acetoacetate (CH₃—C(═O)—CH₂—C(═O)—O—CH₂CH₃) (acylation) and CO₂ and ethanol are then eliminated thermally, siloxane polymers containing radicals B¹ of the formula (II) in which R¹=—C₁₀H₂₀—, R³=H, R⁴=H and R⁵=—CH₃ are obtained.

Processes for preparing β-ketocarbonyl-functional siloxane polymers containing radicals B¹ of the formula (III) are described in DE 1193504 A and DE 1795563A. Preference is here given to the hydrosilylation of allylacetylacetone which forms siloxane polymers containing radicals B¹ of the formula (III) in which R¹=—C₃H₆—, R³=H, R⁶=R⁷=—CH₃. A further preferred process is alkylation of acetylacetone by means of siloxane polymers having Si-bonded halogen groups, e.g. —CH₂Cl, —CH₂Br, —C₃H₆Cl or —C₃H₆I.

Processes for preparing siloxane polymers containing radicals B2 of the formulae (IV) and (V) are described in U.S. Pat. No. 6,121,404 A. They are preferably prepared by reacting diketenes (1) of the general formula

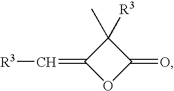

where R³ is as defined above and is preferably a hydrogen atom,
with organosilicon compounds (2) which contain at least one Si-bonded radical A of the general formula

—R¹—(NR²—R¹′)_{z}—NR²₂ (VIII)

per molecule, where R¹, R¹′, R² and z are as defined above, with the proviso that the radical A of the formula (VIII) has at least one primary amino group and if desired at least one secondary amino group, preferably at lest one primary amino group.

The polymer-containing composition comprises a metal-containing compound (IX), preferably a compound (IX) of a metal selected from the group consisting of the transition metals and the lanthanides and main groups 1, 2, 3 and 4 except for boron and carbon in main groups 3 and 4. Preference is given to compounds containing the main group elements Ca, Mg, Al, Si and compounds containing the transition elements Ti, Zr, Cu, Zn, with Ti and Zr being particularly preferred.

The composition preferably comprises organic complexing agents (X) which form complexes with the compounds (IX) in order to control the polymerization and crosslinking.

The additional organic complexing agent (X) is preferably an organic compound containing the group —C(═O)—CR₂—C(═O)— or —C(═O)—CR₂—C(═NR)—, preferably a complexing agent which is volatile below 250° C., more preferably below 200° C., and most preferably below 180° C. Examples of complexing agents are acetylacetone, methyl acetoacetate, ethyl acetoacetate, with particular preference being given to ethyl acetoacetate.

Preference is given to using organic complexing agents (XIII) in an amount of from 0.5 to about 10 mol, more preferably from 1.0 to about 6 mol, per polymer-bonded radical B.

In addition, further additives (XVI) such as solvents, diluents, rheology regulators or organic polymers can be present.

Owing to the very high molecular weights and viscosities which can be achieved by the method of the invention, it may be advantageous for handling reasons to use solvents which fluidize the compositions of the invention. These can, depending on the actual polarities, be all solvents are useful for this purpose. In particular, these are hydrocarbons such as hexane, heptane and octane isomers, petroleum fractions, toluene, xylene, alkylbenzenes and higher homologues of aliphatic and aromatic low boilers and intermediate boilers, alcohols such as methanol, ethanol, propanol, isopropanol, butanol, octanol, 2-ethylhexanol and also ethoxylated and propoxylated alcohols, ketones such as acetone, butanone, methyl isobutyl ketone and cyclohexanone, esters such as ethyl acetate and butyl acetate and also esters of higher homologues of the alcohol constituents and also the acid constituents. Finally, it is also possible to use ethers and polyethers if these have a compatible polarity. The additives (XVI) are preferably used in amounts of a few % to about 4 times the amount of polymer (I). A preferred method of preparing compositions according to the invention is the introduction of metal-containing compound (IX) into the polymer (I) optionally diluted. Particular preference is given to use of a premix of polymer (I) with organic complexing agents (X) before the compound (IX) is added. However, it is also possible to mix the organic complexing agent (X) with the metal-containing compound (IX) and add this mixture to the polymer.

Preference is given, depending on the number of radicals B or E per polymer molecule (I), to using an amount of organic complexing agents (X) which corresponds to from 0.1 to 20 times the molar amount of the radicals B or E, more preferably from the same molar amount to an about 10-fold molar amount.

Pressure and temperature can be varied over a wide range. However, the composition of the invention is preferably prepared in the temperature range from about 10 to about 100° C., more preferably 20-80° C.

The invention further provides a coating process in which the polymer-containing composition of the invention is used. The compositions of the invention are preferably used as coatings, preferably for bladder coating in the tire industry, but also for cosmetics, homecare products such as fabric softeners, textiles, for waterproofing of leather, etc. An advantage of the composition of the invention is its simple and advantageous polymerization.

### EXAMPLES

### Example 1

50.0 g of a linear polydimethylsiloxane (PDMS) having end groups of the formula CH₃C(═O)—CH₂C(═O)—OC₂H₄C(═O)—NHC₃H₆—, a molecular weight Mₙ=33,400 Da, and a viscosity of 4070 mm²/s are diluted with 150.0 g of toluene and admixed with 0.51 g of tetrabutyl titanate. The viscosity increases very quickly and reaches 39 mm²/s (25° C.) in 30 minutes. 5 g of this solution are evaporated in an aluminum dish to give a polymer which has a viscosity above 10,000,000 mPa·s and is again soluble in toluene to give a clear solution. The addition of the titanate increases the viscosity of the polymer by a factor of more than one thousand.

### Example 2

8.1 g of a 75% strength solution of titanium bis(2,4-pentanedionate) diisopropoxide in isopropanol are added to 100.0 g of a linear polydimethylsiloxane which has end groups of the formula CH₃C(═O)—CH₂C(═O)NHC₃H₆—, a molecular weight Mₙ=6000 Da, and a viscosity of 381 mm²/s. The viscosity increases to only 397 mm²/s over a period of 3 hours at 25° C. 5 g of this product maintained at 70° C. in an aluminum dish form a solid film within a few minutes; this film is again soluble in toluene to give a clear solution.

### Example 3

100.0 g of an OH-terminated PDMS, which comprises N-cyclohexylacetoacetamidomethylmethylsiloxy units in a concentration of 0.167 meq/g and has a viscosity of 840 mm²/s (25° C.), are diluted with the same amount of toluene. 1.52 g of titanium bis(2,4-pentanedionate) diisopropoxide dissolved in 4.0 g of isopropanol are added dropwise to the solution. After stirring at 25° C. for 3 hours, the solution attains a viscosity of 295 mm²/s. 5 g of the clear, homogeneous solution are evaporated at 70° C. in an aluminum dish. This gives a solid, clear silicone film which is no longer soluble in toluene. After evaporation of the solution, the acetoacetamido-PDMS used has been crosslinked to form a 3-dimensional network whose linkage points comprise titanium chelate complexes.

### Example 4

100.0 g of a 50% strength solution of an OH-terminated PDMS in toluene, which at a viscosity of 2350 mm2/S (25° C.) has a concentration of N-cyclohexylacetoacetamidomethylmethylsiloxy units of 0.027 meq/g, are diluted with 150 g of toluene to a solids content of 20%. The acetoacetamidosiloxane itself as a solvent-free polymer has a viscosity of 190 Pa·s (25° C.). At 25° C., 5.71 g of ethyl acetoacetate and 0.33 g of an 80% strength solution of zirconium butoxide are introduced in succession into this diluted solution which is stirred well during the addition so that the two substances are homogeneously dispersed as quickly as possible. After a total stirring time of two hours, a clear solution having a viscosity of 7100 mm²/s (25° C.) is obtained.

A sample of this solution is applied in a wet layer thickness of about 5 μm to paper by means of a doctor blade and air dried. Treatment for only 10 seconds at 150° C. in a drying oven gives a vulcanized silicone coating. Linear PDMS chains have been crosslinked by means of zirconium chelate complexes.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A polymer-containing composition comprising:
a) at least one polymer (I) containing at least two functional groups selected from the group consisting of β-ketocarbonyl and β-enaminocarbonyl functions,
b) at least one compound (II) of a metal selected from the group consisting of the transition metals and the lanthanides and main groups 1, 2, 3 and 4 with the exception of boron and carbon.

2. A polymer-containing composition, wherein at least one polymer is a polymer selected from the group consisting of polyesters, polyamides, polyethers, polyethylene oxides, and siloxane polymers.

3. The polymer-containing composition of claim 2, wherein at least one polymer is a linear polysiloxane having the functional groups at the ends of the polymer chain, in lateral positions along the polymer chain, or both at the ends of the polymer chain and in lateral positions along the polymer chain.

4. The polymer-containing composition of claim 2, wherein at least one polymer is a siloxane polymer which is a branched polysiloxane having the functional groups at the ends of the chain(s), in lateral positions along the chain, both at the ends of the chain and in lateral positions along the chain, additionally at branching points, or only at branching points.

5. The polymer-containing composition of claim 1, wherein the metal-containing compound (II) is a compound (IX) of a metal from main groups 1, 2, 3 and 4 except for boron and carbon, or a transition metal.

6. The polymer-containing composition of claim 1, wherein the metal-containing compound (IX) is a compound of the main group elements Ca, Mg, Al, or Si or a compound of the transition elements Ti, Zr, Cu, or Zn.

7. The polymer-containing composition of claim 1, which additionally contains an organic complexing agent (X) which can form complexes with the compounds (II).

8. The polymer-containing composition of claim 7, wherein the additional organic complexing agent (X) is an organic compound containing the group —C(═O)CR₂—C(═O)— or —C(═O)—CR₂—C(═NR)—.

9. A process for coating a substrate, comprising applying to said substrate a polymer-containing composition of claim 1.
